(19) United States
(12) Patent Application Publication
(10) Pub. No.: US 2017/0333979 A1
(43) Pub. Date: Nov. 23, 2017

(54) METHOD FOR MANUFACTURING A COMPRESSOR IMPELLER

(71) Applicant: Siemens Aktiengesellschaft, Munich (DE)

(72) Inventor: Olaf Hannemann, Duisburg (DE)

(73) Assignee: Siemens Aktiengesellschaft, Munich (DE)

(21) Appl. No.: 15/533,216

(22) PCT Filed: Oct. 30, 2015
(86) PCT No.: PCT/EP2015/078004

§ 371 Date: Jun. 5, 2017

(30) Foreign Application Priority Data
Dec. 12, 2014 (DE) 10 2014 225 674.7

(51) Int. Cl. B22C 9/04; B22C 7/02; B22C 9/10; B28B 1/14; B33Y 80/00; F04D 29/32; F04D 29/28

(52) U.S. Cl. CPC B22C 9/04; B28B 1/14; B22C 7/02; B33Y 80/00; B22C 9/10; F04D 29/284; F04D 29/321

(57) ABSTRACT

A method for manufacturing a compressor impeller wherein the compressor impeller is cast using a mold. As a first alternative, the mold is made using 3D printing. As a second alternative, a model of the compressor impeller is made using 3D printing, and the mold is then made on the basis of said model.

### CROSS REFERENCE TO RELATED APPLICATIONS

This application is the US National Stage of International Application No. PCT/EP2015/078004 filed Nov. 30, 2015, and claims the benefit thereof. The International application claims the benefit of German Application No. DE 102014225674.7 filed Dec. 12, 2014. All of the applications are incorporated by reference herein in their entirety.

### FIELD OF INVENTION

The present invention relates to a method for manufacturing a compressor impeller by means of a casting method.

### BACKGROUND OF INVENTION

Despite casting methods being already used nowadays in the manufacturing of compressor impellers, complex impellers cannot be cast to the final shape thereof. Instead, the cast impeller has to be post-machined in order to be finally shaped, as is described in JP 558119998 A, for example. Moreover, an impeller which can be manufactured by means of a casting process is known from US 2002/0187060 A1. However, in comparison to other impellers, the geometry in the case of this impeller has been simplified with a view to the manufacturing by means of the casting method. However, compressor impellers having blade geometries that are optimized in terms of aerodynamics are significantly more complex and cannot be readily manufactured by means of a casting method.

### SUMMARY OF INVENTION

Against the background of this prior art it is an object of the present invention to provide a method for manufacturing compressor impellers that enables casting of even complex compressor impellers without the need for post-machining the blades and the blade ducts.

This object is achieved by a method for manufacturing a compressor impeller, as claimed. The dependent claims include advantageous design embodiments of the invention.

In the method according to the invention for manufacturing a compressor impeller, the compressor impeller is cast with the aid of a casting mold. In a first alternative, the casting mold is manufactured by means of 3-D printing. In a second alternative, a pattern of the compressor impeller is manufactured by means of 3-D printing, the casting mold then being manufactured by means of said pattern. In other words, either the casting mold per se or the pattern that is used for the manufacturing process of the casting mold is manufactured by means of 3-D printing technology. This enables molds or patterns, respectively, having complex geometries to be manufactured, which molds, in the case of a mold that is manufactured by means of 3-D printing, can then be directly employed in the casting process, or which patterns, in the case of a pattern that is manufactured by means of 3-D printing, can be utilized for manufacturing the casting mold that is used in the casting process.

By virtue of the possibility of manufacturing even highly complex geometries in a precise and reproducible manner by means of 3-D printing, the method according to the invention offers the possibility of casting also compressor impellers having complex geometries, without post-casting machining of the blades and of the blade ducts being necessary on the cast compressor impeller. By contrast, the patterns, usually wooden patterns, that have been used to date for manufacturing the casting molds are insufficiently accurate for manufacturing highly complex compressor impeller geometries. Moreover, the molds and patterns which are typically single-use molds or single-use patterns, so-called lost molds or lost patterns, respectively, have to be manufactured anew for each casting, this being easier to manage in the case of a mold that is manufactured by means of 3-D printing, or of a pattern that is manufactured by 3-D printing, respectively, than in the case of a wooden pattern. On account thereof, patterns can be manufactured not only more accurately but also more rapidly.

The casting mold can comprise at least one casting core which is manufactured by means of 3-D printing, or which is manufactured based on a pattern which is manufactured by means of 3-D printing.

In the context of the method according to the invention, the compressor impeller can be manufactured by means of a sand casting method. In this case, the sand mold can be manufactured directly by means of 3-D printing, using a sand-type printing material as a base material. Alternatively, there is also the possibility of establishing a pattern of the compressor impeller by means of 3-D printing, from which a casting mold that is used in the casting method is then shaped. As an alternative to the use of a sand casting method, a precision casting method can be applied for casting the compressor impeller, in which a lost pattern, for example a wax pattern, is molded, typically by means of 3-D printing, said lost pattern being capable of being chemically removed, combusted, or melted from the finished mold. However, the pattern in the case of the sand casting method can also be a lost pattern.

By using a 3-D print based on 3-D data for manufacturing a pattern of the compressor wheel to be cast, or for manufacturing the casting mold of the compressor wheel to be cast, substantially tighter tolerances can be applied in the production of the impeller, said significantly tighter tolerances enabling even compressor impellers having complex geometries to be manufactured by casting methods.

Further features, properties, and advantages of the present invention are derived from the description hereunder of exemplary embodiments with reference to the appended figures.

### BRIEF DESCRIPTION OF THE DRAWINGS

In the figures:

FIG. 1 shows a flow diagram for a first exemplary embodiment of the method according to the invention;

FIG. 2 shows a flow diagram for a second exemplary embodiment of the method according to the invention.

### DETAILED DESCRIPTION OF INVENTION

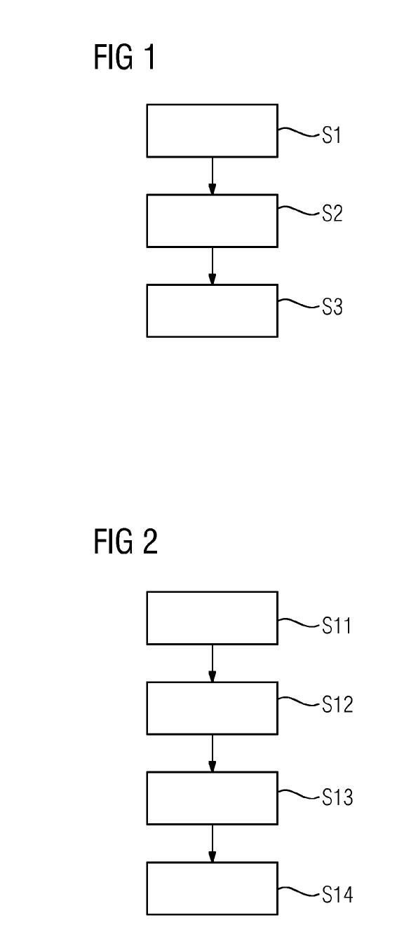

A first exemplary embodiment of the method according to the invention in which a compressor impeller is manufactured by means of a sand casting method is described hereunder with reference to FIG. 1.

In the first step S1 of the sand casting method of the first exemplary embodiment, a sand mold for the casting is manufactured by means of 3-D printing. Stored 3-D data which represents the contour of the negative of the compressor impeller to be cast is used for 3-D printing. By layering sand particles, the mold can be manufactured in a reproducible manner in 3-D printing, or mold parts that are subsequently assembled to form the mold can be manufactured in a reproducible manner. Mold parts of the mold herein can be either different portions of the mold and/or casting cores that are to be inserted into the mold.

In step S2, liquid metal from which the compressor impeller is to be manufactured is poured into the mold through a filler opening. Metals such as, for example, titanium, aluminum, or steel are to be considered.

Upon solidification of the metal that has been poured into the mold, the mold is removed from the compressor impeller in step S3, the mold being destroyed therein, which is why the mold is a lost mold.

A second exemplary embodiment of the method according to the invention will be described hereunder with reference to FIG. 2. In this exemplary embodiment, it is not the casting mold per se but a pattern of the compressor impeller that is used for manufacturing the casting mold that is manufactured by means of 3-D printing. Accordingly, the first step S11 of the method according to the second exemplary embodiment is the manufacturing of a compressor impeller pattern by means of 3-D printing, wherein stored 3-D data which represents the contour of the compressor impeller is used, so as to construct the compressor impeller pattern in a layer-by-layer manner from a plastics material, a wax, or a metal, for example. In the present exemplary embodiment, the compressor impeller pattern is constructed in layers from a polymer material which can be thermally or chemically decomposed.

In step S12, the model is surrounded using a plurality of sequentially applied ceramics layers and subsequently fired, the pattern being thermally decomposed therein. This too is a lost pattern.

Once the ceramics casting pattern has been fired and the pattern thermally decomposed therein, the metal from which the compressor impeller is to be manufactured is poured into the ceramics casting mold in step S13. As in the first embodiment, steel, aluminum, or titanium are to be considered as suitable metals, for example.

Upon solidification of the metal, the ceramics casting mold is removed from the compressor impeller in step S14, the ceramics casting mold being destroyed therein.

The present invention for the purpose of explanation has been explained in more detail by means of two exemplary embodiments. However, a person skilled in the art will be aware that deviations from the exemplary embodiments are possible within the scope of the invention. For example, instead of a chemically or thermally decomposable plastics material used for manufacturing the compressor impeller pattern in the second exemplary embodiment, a plastics material, a wax, or a metal which can be removed from the solidified ceramics mold by melting can thus be used. This offers the advantage that the material removed by melting can be used for manufacturing further compressor impeller patterns. The present invention is therefore not intended to be limited exclusively by the combination of features of individual exemplary embodiments, but only by the appended claims.

1. A method for manufacturing a compressor impeller, the method comprising:
casting the compressor impeller with the aid of a casting mold,
wherein the casting mold is manufactured by means of 3-D printing, or a pattern of the compressor impeller is established by means of 3-D printing, the casting mold then being manufactured by means of said pattern.

2. The method as claimed in claim 1,
wherein the casting mold comprises at least one casting core which is manufactured by means of 3-D printing, or which is manufactured based on a pattern which is established by means of 3-D printing.

3. The method as claimed in claim 1,
wherein the casting mold is a lost mold.

4. The method as claimed in claim 1,
wherein the compressor impeller is cast by means of a ceramics casting method or by means of a sand casting method or by means of a precision casting method.

5. The method as claimed in claim 1,
wherein a lost pattern is used as the pattern for establishing the casting mold.
